(19) United States
(12) Patent Application Publication
(10) Pub. No.: US 2009/0040559 A1
(43) Pub. Date: Feb. 12, 2009

(54) IMAGE FORMING APPARATUS, IMAGE FORMING METHOD, AND IMAGE PROCESSING PROGRAM

(76) Inventor: Shuji HAMADA, Kanagawa (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 12/181,551

(22) Filed: Jul. 29, 2008

(30) Foreign Application Priority Data
Aug. 10, 2007 (JP) 2007-209779
Jun. 10, 2008 (JP) 2008-152117

(51) Int. Cl. G06K 15/00; H04N 1/40

(52) U.S. Cl. 358/1.16; 358/471

(57) ABSTRACT

A storing unit stores therein correspondence information between a pixel value of a pixel and a layout and pixel values of a plurality of pixels obtained by increasing a resolution of the pixel for each main scanning direction. A replacing unit replaces each pixel of image data input from an input unit with a layout and pixel values of a plurality of pixels based on the correspondence information for each main scanning direction. Each of a plurality of writing units having different main scanning directions performs a writing process using the layout and the pixel values of the pixels replaced by the replacing unit following each main scanning direction.

### CROSS-REFERENCE TO RELATED APPLICATIONS

The present application claims priority to and incorporates by reference the entire contents of Japanese priority document 2007-209779 filed in Japan on Aug. 10, 2007 and Japanese priority document 2008-152117 filed in Japan on Jun. 10, 2008.

### BACKGROUND OF THE INVENTION

1. Field of the Invention

The present invention relates to an image forming apparatus, an image forming method, and an image processing program capable of writing image data in high resolution.

2. Description of the Related Art

Recently, an image forming apparatus such as a printer progressively employs high density, and a printer of writing at 1,200 dots per inch (dpi) has been in practical application. Meanwhile, a digital copying machine having also a printer function has long been in the market, but mainly has a copying function of 600 dpi. Assuming there is a multi function peripheral having a combination of a printer of 1,200 dpi and a digital copying machine of 600 dpi, it is considered possible to achieve printing of a copy image of 600 dpi, by outputting the same data of 1,200 dpi by 2×2 dots in both a main scanning direction and a sub-scanning direction, without changing the rotation number of a polygon mirror and a print-pixel clock frequency.

In general, a frequency of a print-pixel clock signal is proportional to a product of a writing density in a main scanning direction and a writing density in a sub-scanning direction. Therefore, a frequency of a print-pixel clock signal of a printer engine of 1,200×1,200 dpi is four times a frequency of a print-pixel clock signal of a printer engine of 600×600 dpi, when both printers have the same line velocity. For example, when a frequency of a print-pixel clock signal of a 600 dpi printer at about 20 parts-per-million (ppm) is 25 megahertz, a high-speed print-pixel clock-signal frequency having 100 Megahertz is necessary to set this printer at 1,200 dpi.

While there are various systems of LD multi-value modulation as described above, when a frequency of a print-pixel clock signal becomes faster, it becomes more difficult to take many multi-value modulations. For example, a system that performs a pulse width modulation (PWM) based on a high-speed clock signal using a phase-locked loop (PLL) is known. Based on this, a clock signal of a frequency of 400 Megahertz is generated within an integrated circuit (IC). A pixel clock-pulse signal of 100 Megahertz which is pulse-width modulated in the resolution of a quarter can be output from this clock signal. In this case, a multi-value resolution of one dot at the time of writing at 1,200 dpi can be selected from five ways at each one quarter, that is, pulse widths of 0, ¼, ½, ¾, and 1. Therefore, five-value PWM is obtained.

In outputting an image of 600 dpi with this printer, a five-value modulation can be performed for one dot of 600 dpi, when the same data is printed out for each 2×2 dots in the main scanning and sub-scanning directions of 1,200 dpi. Alternatively, when a system of allocating data different for each pixel having double density in the main scanning direction is used, a PWM of eight divisions in the main scanning direction can be realized. Therefore, nine-value modulation can be performed. In this case, at the time of outputting an image of 1,200 dpi by the five-value PWM based on a low-resolution image of 600 dpi, multi-value resolution increases to nine values, and an image can be output in high image quality.

As explained above, at the time of outputting image data of low resolution with a high-resolution printer engine, dots increased by increasing the resolution to high resolution are considered as one set. A pulse width of the PWM modulation is determined in this set unit, instead of outputting the data for printing by simply copying the same data by plural dots. With this arrangement, secure concentration expression can be achieved in the print result, without depending on substantial resolution of an optical writing unit.

The invention disclosed in Japanese Patent Application Laid-open No. 2002-356008 has been known to the public, as an invention that makes the concentration expression possible. This invention provides an image forming apparatus that forms an image by polarization scanning an optical beam, to enable a high-resolution printer engine to output a low-resolution image in high image quality by increasing multi-value resolution of a multi-beam image forming apparatus. This image forming apparatus includes a data converting unit that converts input image data of plural bits into data for assigning a pulse width or intensity of the optical beam. This data converting unit is configured to be continuously input with image data of one scanning line at plural number of times, and to perform a data conversion different for a scanning line at each time.

However, according to the invention of Japanese Patent Application Laid-open No. 2002-356008, while printing is performed by reading print data from a memory, resolution is increased as follows. First, the print data is read from the memory, and is converted into image data corresponding to an image of high resolution. The converted image data is written back to the memory, and printing is performed based on the written-back image data. According to this type of technology, the converted image data is written back to the memory as a general practice. Printing of the converted data without writing back the data into the memory is not performed.

On the other hand, an image forming apparatus such as a printer has progressively higher density, and printers that write image data at a density of 1,200 dpi, 4,800 dpi, or the like have been in practical application. However, when data of 1,200 dpi or 4,800 dpi is used in the memory, the memory amount increases and this greatly affects printing performance of the printer.

### SUMMARY OF THE INVENTION

It is an object of the present invention to at least partially solve the problems in the conventional technology.

According to an aspect of the present invention, there is provided an image forming apparatus including a storing unit that stores therein correspondence information between a pixel value of a pixel and a layout and pixel values of a plurality of pixels obtained by increasing a resolution of the pixel for each main scanning direction at time of performing a printing operation; an input unit that inputs image data; a replacing unit that replaces each pixel of the image data with a layout and pixel values of a plurality of pixels corresponding to the pixel based on the correspondence information stored in the storing unit for each main scanning direction; and a plurality of writing units having different main scanning directions each performing a writing process using the layout and the pixel values of the pixels replaced by the replacing unit following each main scanning direction.

Furthermore, according to another aspect of the present invention, there is provided an image forming method configured to be executed in an image forming apparatus including a storing unit that stores therein correspondence information between a pixel value of a pixel and a layout and pixel values of a plurality of pixels obtained by increasing a resolution of the pixel for each main scanning direction at time of performing a printing operation. The image forming method including inputting image data; replacing each pixel of the image data with a layout and pixel values of a plurality of pixels corresponding to the pixel based on the correspondence information stored in the storing unit for each main scanning direction; and writing including each of a plurality of writing units having different main scanning directions performing a writing process using the layout and the pixel values of the pixels replaced at the replacing following each main scanning direction.

Moreover, according to still another aspect of the present invention, there is provided a computer program product comprising a computer-usable medium having computer-readable program codes embodied in the medium configured to be executed in an image forming apparatus including a storing unit that stores therein correspondence information between a pixel value of a pixel and a layout and pixel values of a plurality of pixels obtained by increasing a resolution of the pixel for each main scanning direction at time of performing a printing operation. The program codes when executed causes a computer to execute inputting image data; replacing each pixel of the image data with a layout and pixel values of a plurality of pixels corresponding to the pixel based on the correspondence information stored in the storing unit for each main scanning direction; and writing including each of a plurality of writing units having different main scanning directions performing a writing process using the layout and the pixel values of the pixels replaced at the replacing following each main scanning direction.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a block diagram of a schematic configuration of an image forming apparatus according to an embodiment of the present invention;

FIG. 2 depicts a transfer state by a DMCA of print data stored in a memory;

FIG. 3 depicts a difference of a method of taking out print data based on a paper feeding direction;

FIG. 4 is one example of a writing processor;

FIG. 5 is a conceptual view of a conversion of resolution of color-mixed pixels (600 dpi) of cyan and yellow, using the same conversion table for each photosensitive drum;

FIG. 6 is one example of a conversion table;

FIG. 7 is an image of output data actually output based on the conversion table and a matrix shown in FIG. 6;

FIG. 8 is a conceptual view of a conversion of resolution of color-mixed pixels (600 dpi) of cyan and yellow, using a conversion table of a difference in presence of mirroring depending on a difference of a main scanning direction of each photosensitive drum;

FIG. 9 depicts a relationship between front side printing and backside printing performed by a tandem image forming apparatus that writes data in opposite optical scanning directions from that shown in FIG. 4;

FIG. 10 is one example of a conversion table of front side printing and backside printing;

FIG. 11 is an image of output data actually output based on the conversion table of FIG. 10 in a top mode;

FIG. 12 is one example of a conversion table for mirroring; and

FIG. 13 is an image of output data actually output based on the conversion table of FIG. 12 in a left mode.

### DETAILED DESCRIPTION OF THE PREFERRED EMBODIMENTS

Exemplary embodiments of the present invention will be explained below in detail with reference to the accompanying drawings.

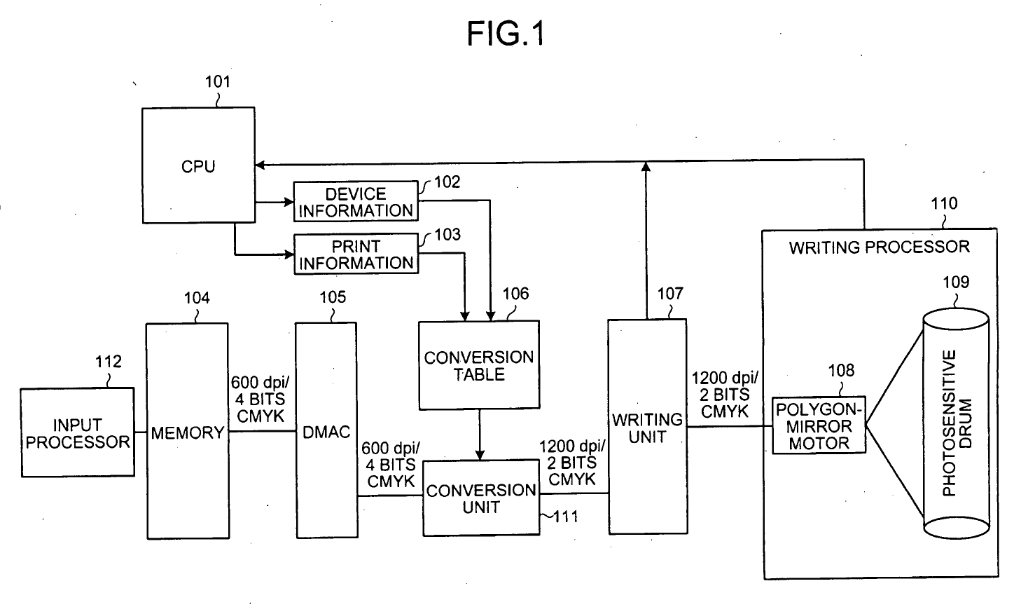

FIG. 1 is a block diagram showing a schematic configuration of an image forming apparatus according to an embodiment of the present invention. In FIG. 1, the image forming apparatus according to the present embodiment basically includes a central processing unit (CPU) 101, a memory 104, a direct memory access (DMAC) 105, a conversion table 106, a writing unit 107, a writing processor 110, a conversion unit 111, and an input processor 112.

The CPU 101 transmits device information 102 or print information 103 to the conversion table 106. The CPU 101 develops a program code stored in a read only memory (ROM) (not shown) or a program code received from the outside, into a random access memory (RAM) (not shown), and performs a control following the program code.

Print data is stored in the memory 104. While the memory 104 stores the data of 600 dpi/4 bits, a data format is not limited to this. The DMAC 105 reads the print data stored in the memory 104. The conversion unit 111 converts the print data into data suitable for the writing processor 110. The conversion table 106 is used to convert the data.

The conversion table 106 determines a conversion system using the device information 102 or the print information 103. In the present embodiment, the conversion table 106 holds pixel values of pixels of 600 dpi/4 bits, layout of plural pixels and pixel values when the pixels are converted into high resolution of 1,200 dpi/2 bits, in the main scanning direction and for each printing side at the time of printing, by relating these pixel values and the layout to each other. The conversion table 106 is stored in a storing unit such as a RAM and a ROM.

Because the conversion table 106 is used in the present embodiment, data of 600 dpi/4 bits can be converted into data of 1,200 dpi/2 bits. This data is not limited to the data of 600 dpi/4 bits or the data of 1,200 dpi/2 bits. The print data converted into the data of 1,200 dpi/2 bits in the conversion table is delivered to the writing unit 107, and is then written into and printed by the photosensitive drum 109 via an optical system including a polygon mirror rotated by a polygon-mirror motor 108.

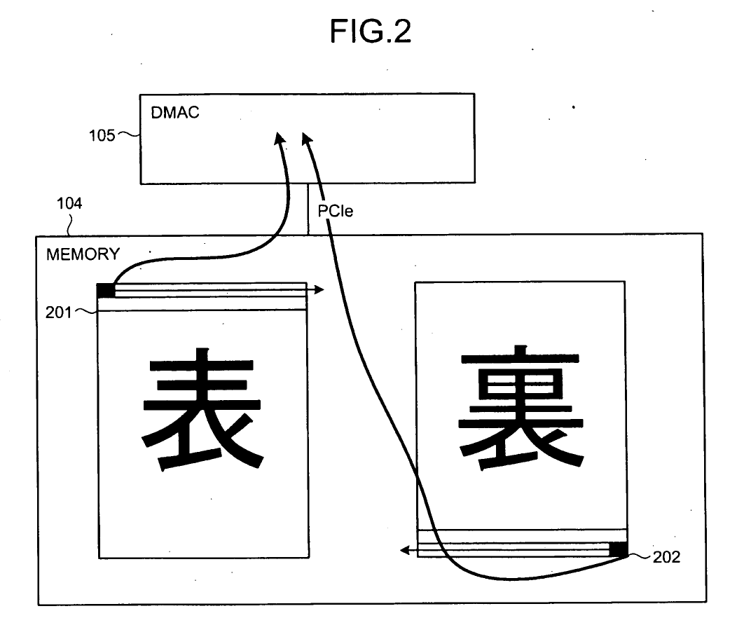

A printing system of the print data stored in the memory 104 is different depending on the configuration of the writing processor 110. FIG. 2 depicts a transfer state by the DMAC 105 of the print data stored in the memory 104. In FIG. 2, reference numeral 201 denotes data to be printed on a front side, and reference numeral 202 denotes data to be printed on a backside, as data stored in the memory 104. The data 201 to be written on the front side is taken out from an upper left side of the print data. On the other hand, the data 202 to be written on the backside is taken out from a lower right side of the print data. The above data takeout method is based on the configuration of the writing processor 110 shown in FIG. 1. That is, in the case of a both-side printing, the printing on the backside is performed by inverting the paper. Depending on a mechanical configuration of the output device, both print data are taken out from the same direction. To make it possible to match both systems, the data 202 on the backside is assumed to be taken out from the lower right side.

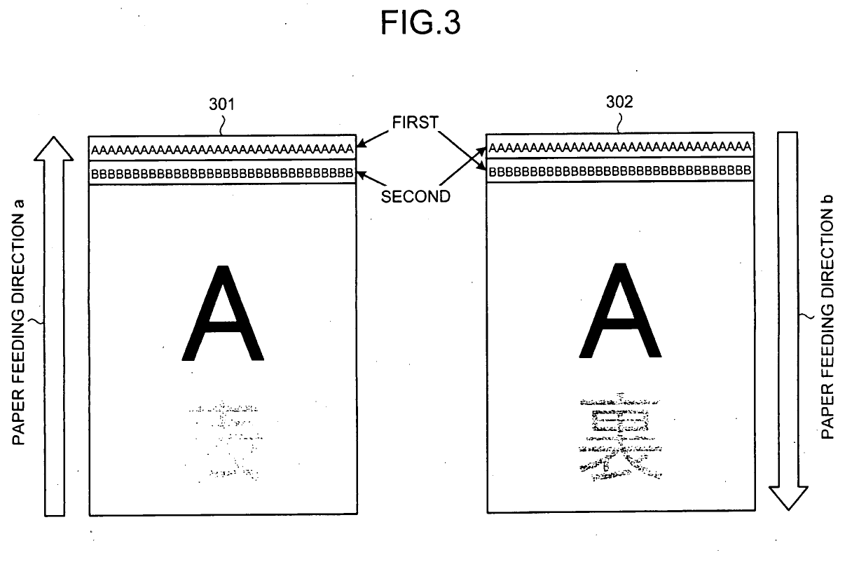

FIG. 3 depicts a difference of a method of taking out the print data based on a paper feeding direction. To print on a front side A301, the paper is fed from bottom upward (in an arrowhead a direction) in FIG. 3. In this case, the print data is printed in the order of AAAAAA and BBBBB from the upper side of the paper. On the other hand, to print on a backside A302, the paper is fed from top downward (in an arrowhead b direction). In this case, the print data needs to be output in the order of BBBBB to AAAAA. For the above reason, in transferring data from the memory, it can be understood that the method of taking out the print data to the front side needs to be changed from the method of taking out the print data to the backside. Similarly, in increasing the resolution of one pixel into plural pixels in the paper feeding direction, to avoid change of color between the front side and the backside, different conversion tables need to be used to print on the front side and to print on the backside, and also the pixel layout in the paper feeding direction needs to be opposite between the conversion table.

The input processor 112 performs an input process of image data, and stores the input image data into the memory 104.

The conversion unit 111 converts the image data taken out from the memory 104 by the DMAC 105 in FIG. 1, and the writing processor 110 converts the pixel output based on the print information 103 of the front side or the backside. The device information 102 is used to register a mechanical configuration of the writing processor 110.

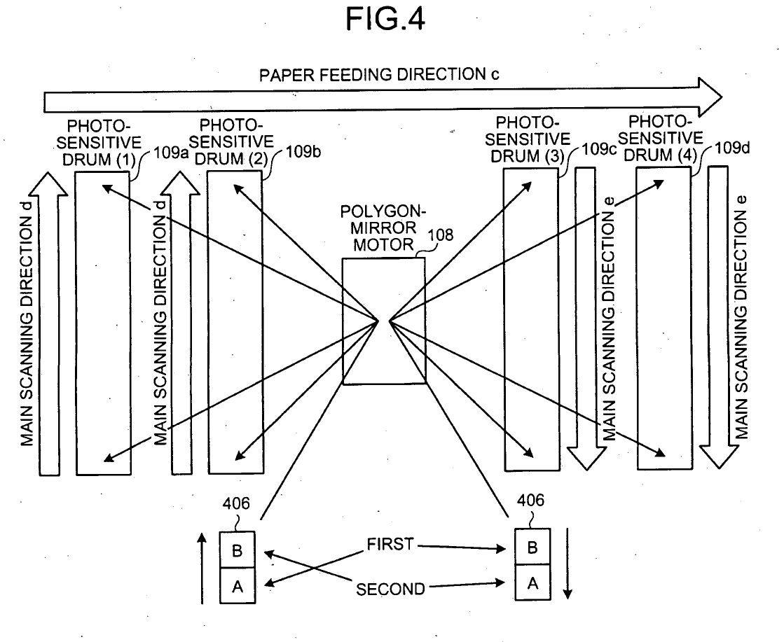

FIG. 4 is one example of the writing processor 110. FIG. 1 depicts a color image forming apparatus of a so-called tandem type, having first to fourth photosensitive drums (1) to (4) (109a, 109b, 109c, and 109d) arranged in order along a paper feeding direction. An optical system using a polygon mirror driven by a polygon-mirror motor 405 optically writes data. In this example, the writing processor 110 has a laterally symmetrical configuration around the polygon-mirror motor 405 that rotationally drives the polygon mirror. Even when this configuration is different, the effect of the present invention remains unchanged. The first photosensitive drum (1) 109a, the second photosensitive drum (2) 109b, the third photosensitive drum (3) 109c, and the fourth photosensitive drum (4) 109d are allocated respectively with CMYK (cyan, magenta, yellow, black) colors of a general image forming apparatus.

In the present embodiment, as one example, the first photosensitive drum (1) 109a performs a writing process in cyan, the second photosensitive drum (2) 109b performs a writing process in magenta, the third photosensitive drum (3) 109c performs a writing process in yellow, and the fourth photosensitive drum (4) 109d performs a writing process in black.

The number of photoconductors can change depending on a toner color. When the paper is fed from left to right (an arrowhead c direction) as shown in FIG. 4, a known optical system using a polygon mirror driven by the polygon-mirror motor 108 writes the print data onto the photosensitive drums 109a to 109d.

However, depending on a mechanical configuration, the photosensitive drums 109a to 109d are not necessarily in the same direction. For example, in the present embodiment, a main scanning writing direction on the first photosensitive drum (1) 109a and the second photosensitive drum (2) 109b is from bottom upward (an arrowhead d direction). However, a main scanning writing direction on the third photosensitive drum (3) 109c and the fourth photosensitive drum (4) 109d is from top downward (an arrowhead e direction). This is because the polygon mirror is driven by the polygon-mirror motor 108 that is coaxial with the polygon mirror, and the optical writing direction becomes the rotation direction of the polygon-mirror motor 108. Therefore, the two photosensitive drums are laid out in a pair by sandwiching the polygon mirror.

When the main scanning writing pixels are a pixel A and a pixel B, for example, the first photosensitive drum (1) 109a and the second photosensitive drum (2) 109b are written with the pixels A and B in this order, as shown by reference numeral 406. However, the third photosensitive drum (3) 109c and the fourth photosensitive drum (4) 109d need to be written with the pixels B and A in this order, as shown by reference numeral 407. This is due to the design of the machine of the image forming apparatus. To satisfy this constraint of the mechanical configuration, the controller that reads the print data from the memory 104 needs to operate satisfactorily. This configuration is called mirroring.

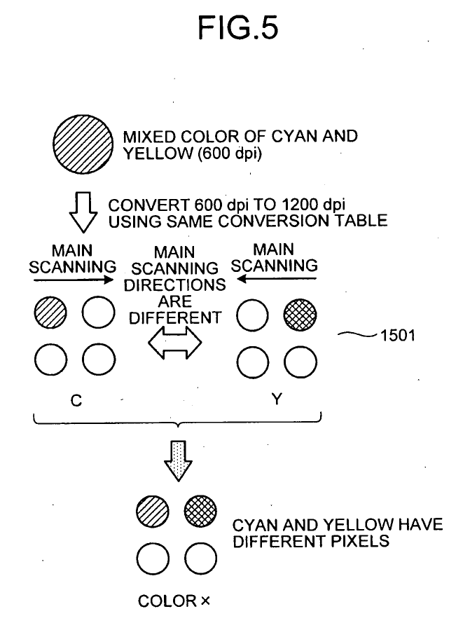

According to the conventional method, when the image of 1,200 dpi is generated from the image data of 600 dpi, and also when a writing process is performed after storing the image data of 1,200 dpi into the memory, the image of the 1,200 dpi stored in the memory is read out following a main scanning direction. While this configuration has no problem, when a conversion is attempted using the conversion table 106 for converting one pixel into four pixels without storing the 1,200 dpi image data into the memory like in the present embodiment, mirroring based on the main scanning direction becomes important. To confirm the importance of this mirroring, converting the image data of 600 dpi into high pixels of 1,200 dpi without performing the mirroring is explained with reference to FIG. 5. In the example shown in FIG. 5, conversion of one pixel into pixels A and B of two dots at an upper stage and into pixels C and D of two dots at a lower stage is explained.

FIG. 5 depicts a concept that resolution of a mixed-color pixel (600 dpi) of cyan and yellow is changed using the same conversion table, on the first photosensitive drum (1) 109a and on the third photosensitive drum (3) 109c having a main scanning direction different from that of the first photosensitive drum (1) 109a. As shown in FIG. 5, at the time of converting the mixed-color pixel of cyan and yellow from 600 dpi into 1,200 dpi, when the same conversion table is used, a pixel of cyan and a pixel of yellow are laid out at different positions as indicated by reference numeral 1501, due to the difference of the main scanning directions. In this case, because the pixel of cyan and the pixel of yellow are laid out at different positions, a user recognizes that image quality is degraded, when referencing a printed original. That is, pixels of colors need to be laid out in the same priority order on the printed paper surface, regardless of the scanning direction.

Referring back to FIG. 1, the device information 102 is given information of the mechanical configuration of the image forming apparatus mirroring in this way.

The conversion unit 111 matches a format of print data on the memory 104 and a format of a writing format in the writing processor 110, using the conversion table 106 based on the device information 102 and the print information 103. The conversion unit 111 according to the present embodiment replaces each pixel of image data of 600 dpi/4 bits with a matrix including a layout of four pixels and pixel values corresponding to each pixel, for each main scanning direction for each printing side, based on the conversion table 106.

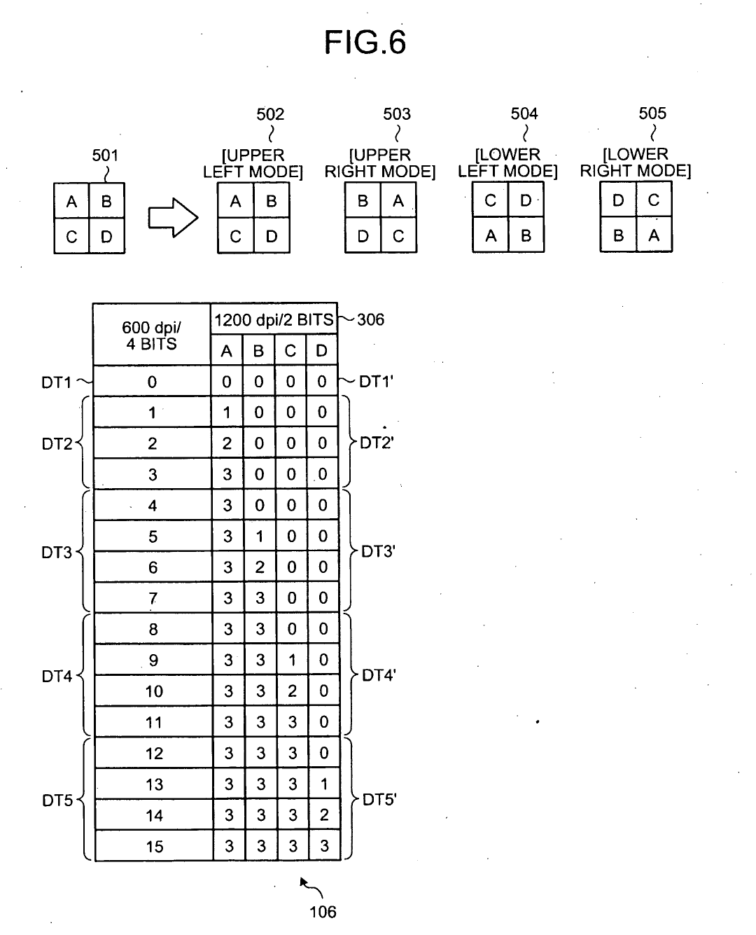

FIG. 6 is one example of the conversion table 106. In this example, data of 600 dpi/4 bits is converted into data of concentration of 1,200 dpi/2 bits. The conversion system can be applied to a control of data conversion of a writing format different from a format on the memory 104, without limiting to the conversion from 600 dpi into 1,200 dpi.

As shown in FIG. 6, the conversion table 106 stores a rule of expressing data of 600 dpi/4 bits in 1,200 dpi/2 bits. This rule holds a priority order of laying out pixels in four matrixes of ABCD for each mode. Further, this rule holds a rule of converting the concentration (a pixel value) expressed in 4 bits for one pixel in 600 dpi (setting a pixel value), into the concentration expressed by 2 bits for one pixel of 1,200 dpi.

Further, in the present embodiment, because one pixel of 600 dpi is converted into a pixel value having a double concentration in the main scanning direction and the sub-scanning direction, the pixel is converted using four kinds of matrixes based on a difference of the main scanning and the sub-scanning directions. In this case, a conversion table mode can be set to reflect the device information 102 and the print information 103 shown in FIG. 1. That is, the conversion table mode can be changed to an upper left mode 502, a top-right mode 503, a bottom-left mode 504, and a bottom-right mode 505. In the above example, the upper and the lower mean front side printing and backside printing at the time of writing. The left and right mean mirroring when the main scanning directions are different. That is, the upper left mode 502 has no mirroring in the front side printing. The top-right mode 503 has mirroring in the front side printing. The bottom-left mode has no mirroring in the backside printing. The bottom-right mode has mirroring in the backside printing.

Different tables (conversion tables) are prepared for the front side printing and the backside printing, to suppress change of colors due to a difference of the sub-scanning directions. As shown in FIG. 2, an image is printed from the top for the front side printing, and an image is printed from the bottom for the backside printing. In this way, sub-scanning directions (paper feeding directions) are different between the front side printing and the backside printing. Therefore, when the same conversion table is sued for the front side printing and the backside printing, pixel values of pixels adjacent in the upper and lower directions are different. Consequently, when the same image data is printed on both the front side and the backside, colors are different due to the change in adjacent pixels. To suppress the change of colors, different matrixes (conversion tables) are used between the front side printing and the backside printing. As explained above, because the change of pixels in the sub-scanning directions due to the change in the sub-scanning directions can be prevented, the change of colors due to the change in adjacent pixels can be suppressed.

The process of converting the concentration of one pixel of 600 dpi expressed by 4 bits in FIG. 6 into the concentration of one pixel of 1,200 dpi expressed by 2 bits is performed for each of the CMYK colors.

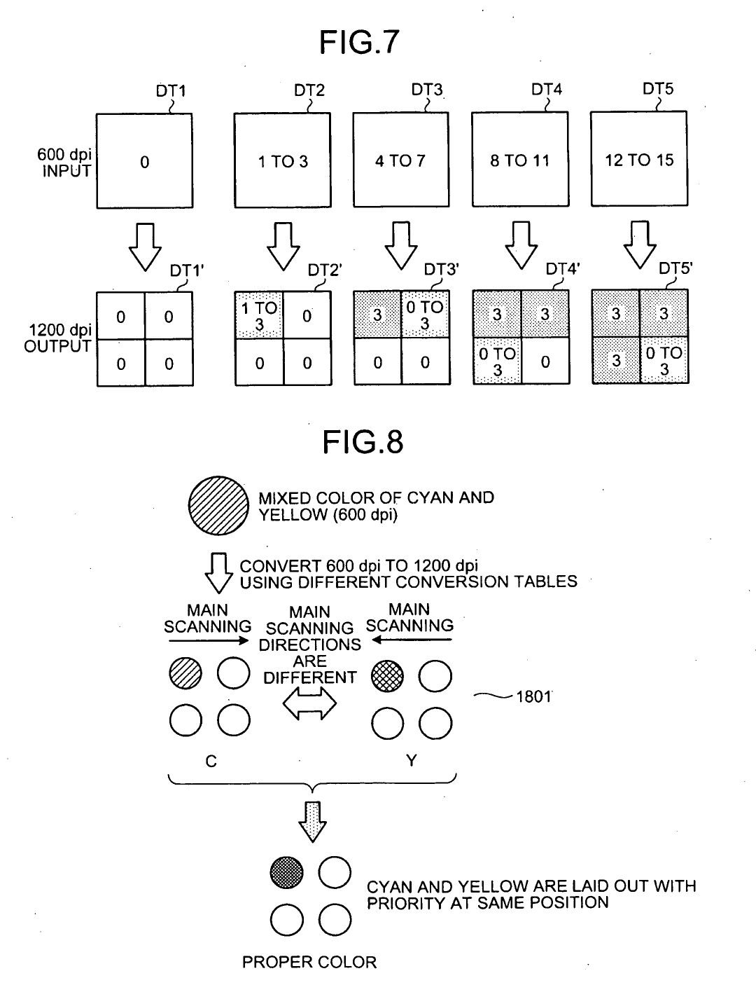

FIG. 7 is an image of output data actually output based on the conversion table and the matrix shown in FIG. 6. FIG. 7 depicts a state that data DT1 of “0”, data DT2 of “1 to 3”, data DT3 of “4 to 7”, data DT4 of “8 to 11”, and data DT5 of “12 to 15” for 600 dpi/4 bits are converted into data DT1′, DT2′, DT3′, DT4′, and DT5′ for 1,200 dpi/2 bits, respectively. That is, for the data DT1′, concentration “0” is allocated to the four matrixes of A, B, C, and D. For the data DT2′, concentrations 1 to 3 are allocated to the matrix A, and concentration 0 is allocated to the matrixes B, C, and D. For the data DT3′, concentration 3 is allocated to the matrix A, concentrations 0 to 2 are allocated to the matrix B, and concentration 0 is allocated to the matrixes C and D. For the data DT4′, concentration 3 is allocated to the matrix A, concentration 3 is allocated to the matrix B, concentration 0 to 3 are allocated to the matrix C, and concentration 0 is allocated to matrix D. For the data DT5′, concentration 3 is allocated to the matrix A, concentration 3 is allocated to the matrix B, concentration 3 is allocated to the matrix C, and concentrations 0 to 3 are allocated to the matrix D. As is clear from FIG. 7, in the conversion table 106, data is converted from left to right and from top to bottom.

For example, the data DT3 of 4 to 7 for 600 dpi/4 bits is converted into the data DT3′. The data values are aligned from left to right. The data DT5 is converted into the data DT5′, and the data are aligned from top downward.

In the present embodiment, as shown in FIG. 7, in the layout after the printing, pixel values shown in 2 bits are set in the priority order of upper left, upper right, lower left, and lower right. In the present embodiment, by using the above conversion table, pixels are laid out in the priority orders for each colors of CMYK, regardless of the main scanning direction and the sub-scanning direction. As a result, the colors are combined properly, and proper color printing can be performed.

FIG. 8 depicts a concept that resolution of a mixed-color pixel (600 dpi) of cyan and yellow is changed using a conversion table of a difference in presence of mirroring, on the first photosensitive drum (1) 109a and on the third photosensitive drum (3) 109c having a main scanning direction different from that of the first photosensitive drum (1) 109a, corresponding to a difference of the main scanning direction. As shown in FIG. 8, at the time of converting the mixed-color pixel of cyan and yellow from 600 dpi to 1,200 dpi, when a different conversion table is used based on presence of mirroring in the main scanning direction, a pixel of cyan and a pixel of yellow are laid out at the same position by the conversion table, as indicated by reference numeral 1801. In this case, because the pixel of cyan and the pixel of yellow are superimposed, a user recognizes that printing is performed in proper colors, when referencing a printed original.

Further, in the present embodiment, modes of “upper left”, “upper right”, “lower left”, and “lower right” can be selected by the conversion unit 111 as shown in FIG. 6. This selection is made possible because the line output sequence needs to be changed between the front side printing and the backside printing to perform a both-side copying, as described with reference to FIG. 3. Specifically, at the time of reading the first-line print data from the memory 104, when the top modes indicated by reference numerals 502 and 503 are selected as a first line, to print this on the backside, the similar line needs to be read as the print data. To convert the mode, the bottom modes indicated by the reference symbols 504 and 505 need to be selected. The DMAC 105 shown in FIG. 1 executes the function of reading one-line data at plural times.

According to the image forming apparatus having a configuration of mirroring explained with reference to FIG. 4, the scanning directions of the first photosensitive drum (1) 109a and the second photosensitive drum (2) 109b, and the output order of the pixels on the third photosensitive drum (3) 109c and the fourth photosensitive drum (4) 109d need to be changed. That is, the pixel output orders need to be changed by mirroring between the left modes indicated by reference numerals 502 and 504 and the right modes indicated by reference numerals 503 and 505 in FIG. 5.

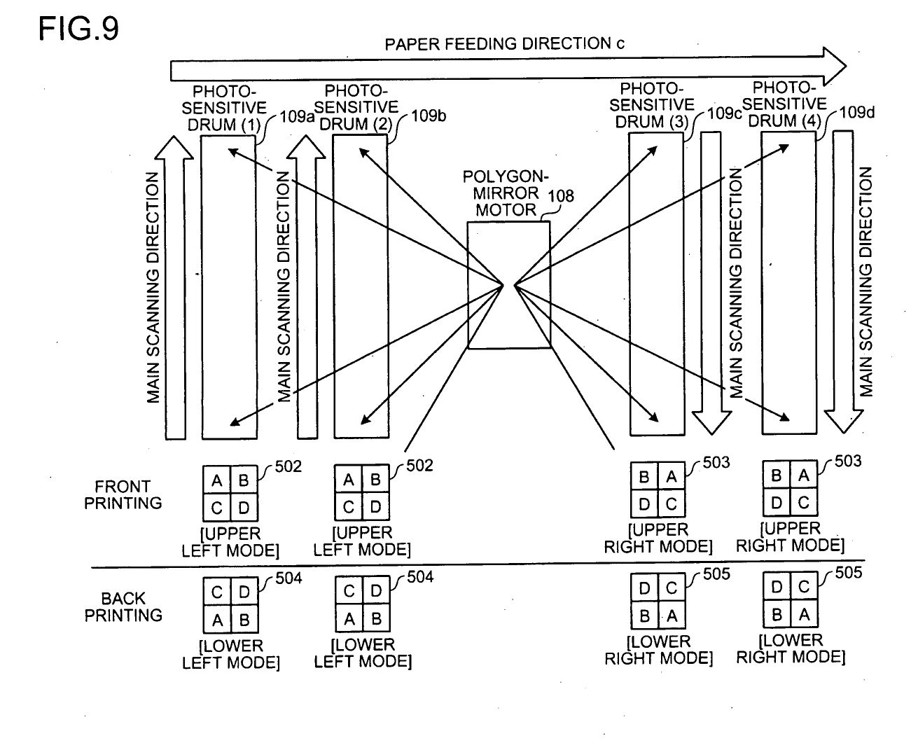

FIG. 9 depicts a relationship between front side printing and backside printing performed by a tandem image forming apparatus that writes data in the opposite optical scanning directions from that shown in FIG. 4. Assume that the conversion table mode upper left (reference numeral 502, see FIG. 4) is selected. For the front side printing, the upper left mode indicated by reference numeral 502 is selected on the first photosensitive drum (1) 109a and the second photosensitive drum (2) 109b. However, on the third photosensitive drum (3) 109c and the fourth photosensitive drum (4) 109d, the optical scanning direction becomes opposite to that on the first photosensitive drum (1) 109a and the second photosensitive drum (2) 109b. Therefore, the top-right mode 503 needs to be selected by mirroring. On the other hand, for the backside printing, the bottom-left mode 504 is selected on the first photosensitive drum (1) 109a and the second photosensitive drum (2) 109b, and the bottom-right modes 505 are selected by mirroring on the third photosensitive drum (3) 109c and the fourth photosensitive drum (4) 109d.

As explained above, the conversion unit 111 converts the image data of CMYK of 600 dpi/4 bits into the CMYK data of 1,200 dpi/4 bits, and outputs the converted data to the writing unit 107.

The writing unit 107 is provided for each color of CMYK. Between the writing units of C and M and the writing units 107 of Y and K, the writing processor 110 actually performs the writing in different main scanning directions. The writing unit 107 performs the writing process in the layout of pixels and in the pixel values replaced by the conversion unit 111 (four pixels from each pixel), following the main scanning direction and the printing side.

The writing unit 107 writes a laser which is laser modulated by the control of the writing unit 107, to a longitudinal direction of the photosensitive drum 109, using a polygon mirror driven by the polygon-mirror motor 108. The writing processor 110 forms an image.

As explained above, according to the present embodiment, the image forming apparatus includes a function of converting a pixel considering mirroring, front side printing, and backside printing, corresponding to a mechanical configuration. Therefore, memory amount can be saved, and performance can be improved. One controller can handle various kinds of mechanical configurations without depending on a specific mechanical configuration. Cost performance can be also improved as a result.

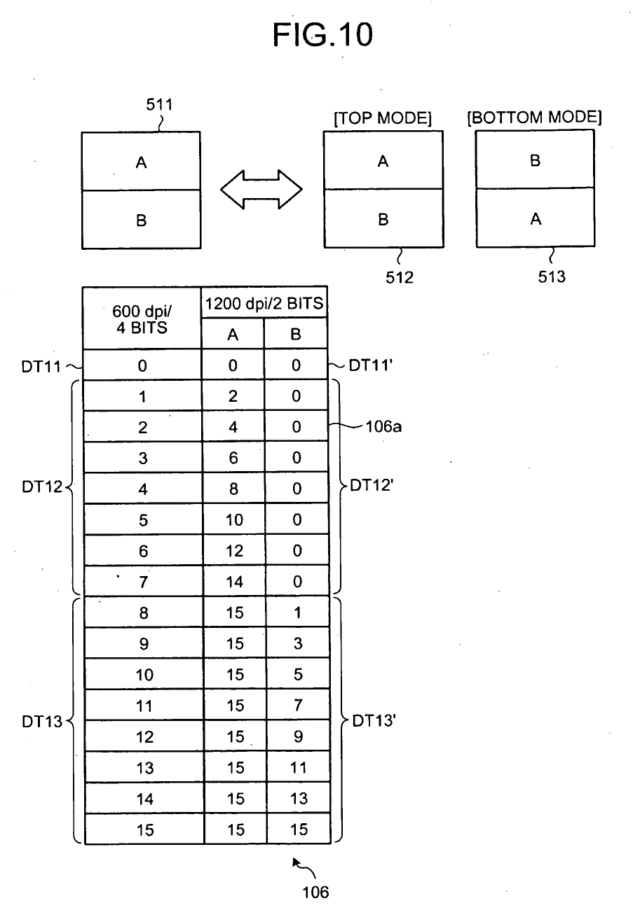

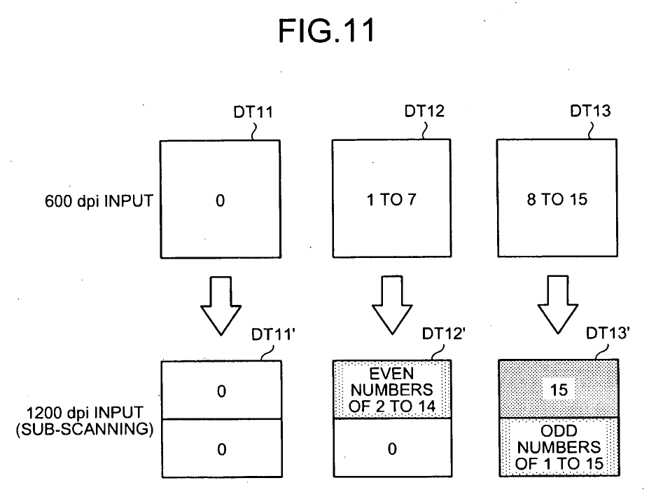

The conversion table shown in FIG. 6 in the present embodiment is one example from 600 dpi/4 bits to the main scanning 1,200 dpi/2 bits and the sub-scanning 1,200 dpi/2 bits. For the conversion system, it is necessary to prepare a table taking into consideration the mirroring, and the front side printing and the backside printing as shown in FIG. 6, depending on the mechanical configuration. FIG. 10 depicts a conversion table taking only the front side printing and the backside printing into consideration. A conversion table 106a shown in FIG. 6 assumes from 600 dpi/4 bits to the main scanning 600 dpi/4 bits and the sub-scanning 1,200 dpi/2 bits. In this case, the front and the backside printing is considered, and only a top mode 512 for printing the front side and a bottom mode 513 for printing the backside for an AB top-and-bottom pattern 511 having the upper side line A and a lower line B. The conversion unit 111 performs the data conversion following a selected mode. FIG. 11 is an image of output data actually output based on the conversion table of FIG. 10 in the top mode 512. FIG. 11 depicts a state of concentration data of A and B after the data conversion of DT 11, 12, and 13, as DT 11′, 12′, and 13′.

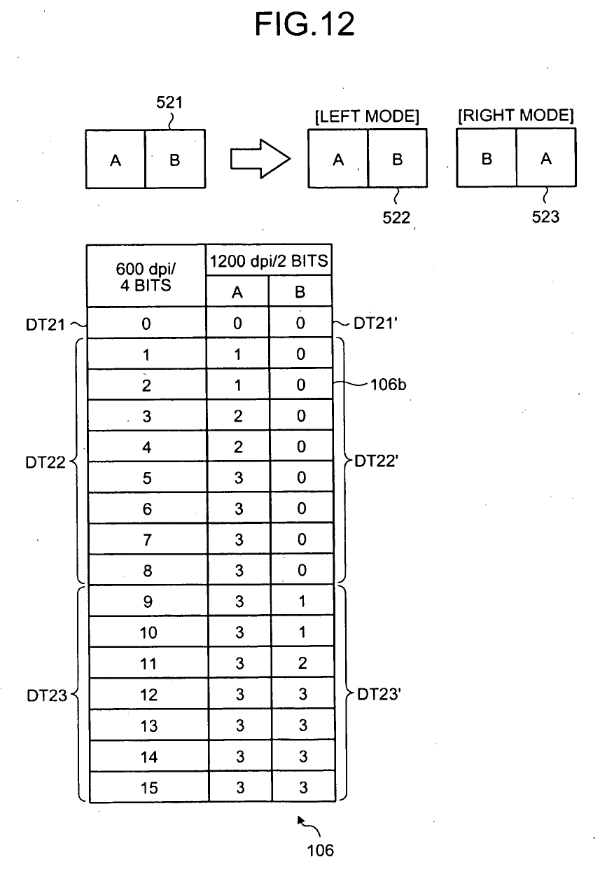

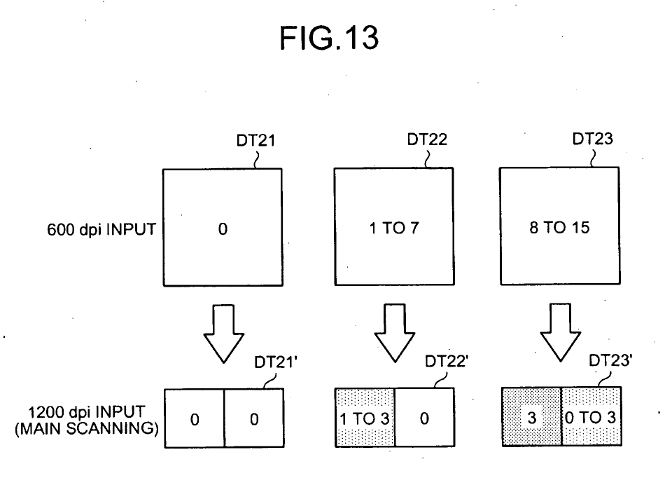

FIG. 12 depicts a table for converting 600 dpi/4 bits to the main scanning 1,200 dpi/2 bits. The conversion table in FIG. 10 can select a left mode 522 and a right mode 523 for AB pattern 521 considering mirroring. FIG. 13 is an image of output data actually output based on the conversion table of FIG. 12 in the left mode 522. FIG. 13 depicts a state of concentration data of A and B after the data conversion of DT 21, 22, and 23, as DT 21′, 22′, and 23′.

The conversion tables 106, 106a, and 106b show examples of conversion of 600 dpi to 1,200 dpi. Various concentration conversions can be considered such as a conversion from 600 dpi to 4,800 dpi. In this case, when a conversion table is prepared corresponding to a conversion system and also when a conversion mode is set selectable, the conversion table can meet different mechanical configurations of printing units that perform both-side printing and mirroring.

According to the present embodiment, there are following effect.

First, because the conversion system is determined using the conversion table 106 based on the device information 102 and the print information 103, the conversion unit 111 can output a pixel suitable for the device configuration, without writing back data to the memory 104 even when a writing system has a data format different from that of data on the memory 104.

Second, at the time of performing a pixel conversion by reflecting the device information 102 showing a device configuration, the pixel conversion can meet mirroring.

Third, at the time of performing a pixel conversion by reflecting the print information 103 showing front side printing and the backside printing, the front side printing and the backside printing can be performed.

Consider performing a rotational printing of a high-resolution image of 1,200 dpi obtained from an image of 600 dpi, following a paper printing direction, without limiting a pixel layout explained in the present embodiment. In this case, a conversion table prepared in advance to avoid change of colors between when a rotation is performed and when a rotation is not performed can be used to lay out pixels in the same process as that explained above. With this arrangement, pixels can be properly laid out to avoid generating change of colors between when a rotation is performed and when a rotation is not performed.

In the present embodiment, an example of increasing the resolution of one pixel to four pixels of 2×2 is explained. However, the present invention can be also applied to increase one pixel to higher resolution such as nine pixels of 3×3, for example.

An image processing program executed by the image forming apparatus according to the present embodiment is provided by being stored in a ROM or the like.

The image processing program executed by the image processing apparatus according to the present embodiment can be recorded in a computer-readable recording medium such as a compact disc-ROM (CD-ROM), a flexible disk (FD), a CD-recordable (CD-R), or a digital versatile disk (DVD) as a file of an installable format or an executable format and provided.

The image processing program executed by the image processing apparatus according to the present embodiment can be stored in a computer connected to a network such as the Internet, and then downloaded via the network to be provided, and image processing program can be provided or distributed via a network such as the Internet.

The image processing program executed by the image forming apparatus according to the present embodiment includes a module configuration stored in each unit described above. As actual hardware, each unit reads the program from the ROM and executes the program, thereby developing the program in a memory region on the unit. The processes of the respective units are can be then performed.

As described above, according to an aspect of the present invention, at the time of performing a writing process by increasing the resolution of image data, the writing process can be performed without storing the high-resolution image data into the memory. With this arrangement, the memory using amount can be reduced, and the writing can be performed by properly laying out the pixels in the main scanning direction. Therefore, image degradation due to the high resolution can be suppressed.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An image forming apparatus comprising:
a storing unit that stores therein correspondence information between a pixel value of a pixel and a layout and pixel values of a plurality of pixels obtained by increasing a resolution of the pixel for each main scanning direction at time of performing a printing operation;
an input unit that inputs image data;
a replacing unit that replaces each pixel of the image data with a layout and pixel values of a plurality of pixels corresponding to the pixel based on the correspondence information stored in the storing unit for each main scanning direction; and
a plurality of writing units having different main scanning directions each performing a writing process using the layout and the pixel values of the pixels replaced by the replacing unit following each main scanning direction.

2. The image forming apparatus according to claim 1, wherein
the storing unit further stores therein the correspondence information for each printing side,
the replacing unit replaces each pixel of the image data with the layout and pixel values of the pixels corresponding to the pixel based on the correspondence information stored in the storing unit for each combination of the main scanning direction and the printing side, and
each of the writing units performs the writing process using the layout and pixel values of the pixels replaced by the replacing unit following each main scanning direction and each printing side.

3. The image forming apparatus according to claim 2, wherein at time of laying out a plurality of pixels by increasing the resolution of a pixel, the storing unit stores therein the correspondence information in which a priority order of setting the pixel values is set, for each combination of the main scanning direction and the printing side.

4. The image forming apparatus according to claim 1, wherein at the time of laying out a plurality of pixels by increasing the resolution of a pixel, the storing unit stores therein the correspondence information in which a priority order of setting the pixel values is set, for each main scanning direction.

5. The image forming apparatus according to claim 1, wherein in the correspondence information, presence of mirroring in the main scanning direction in the layout of a plurality of pixels is different depending on whether the main scanning direction is a forward direction or a backward direction.

6. The image forming apparatus according to claim 1, wherein the writing units have different colors.

7. The image forming apparatus according to claim 1, wherein the correspondence information includes a pixel value of a pixel, and pixel values and positions of four pixels including two dots in a main scanning direction and two dots in a sub-scanning direction obtained by increasing the resolution of the pixel.

8. An image forming method configured to be executed in an image forming apparatus including a storing unit that stores therein correspondence information between a pixel value of a pixel and a layout and pixel values of a plurality of pixels obtained by increasing a resolution of the pixel for each main scanning direction at time of performing a printing operation, the image forming method comprising:
inputting image data;
replacing each pixel of the image data with a layout and pixel values of a plurality of pixels corresponding to the pixel based on the correspondence information stored in the storing unit for each main scanning direction; and
writing including each of a plurality of writing units having different main scanning directions performing a writing process using the layout and the pixel values of the pixels replaced at the replacing following each main scanning direction.

9. The image forming method according to claim 8, wherein
the storing unit further stores therein the correspondence information for each printing side,
the replacing unit replaces each pixel of the image data with the layout and pixel values of the pixels corresponding to the pixel based on the correspondence information stored in the storing unit for each combination of the main scanning direction and the printing side, and
each of the writing units performs the writing process using the layout and pixel values of the pixels replaced by the replacing unit following each main scanning direction and each printing side.

10. The image forming method according to claim 8, wherein in the correspondence information, presence of mirroring in the main scanning direction in the layout of a plurality of pixels is different depending on whether the main scanning direction is a forward direction or a backward direction.

11. The image forming method according to claim 8, wherein the writing units have different colors.

12. A computer program product comprising a computer-usable medium having computer-readable program codes embodied in the medium executed in an image forming method including a storing unit that stores therein correspondence information between a pixel value of a pixel and a layout and pixel values of a plurality of pixels obtained by increasing a resolution of the pixel for each main scanning direction at time of performing a printing operation, the program codes when executed causing a computer to execute:
inputting image data;
replacing each pixel of the image data with a layout and pixel values of a plurality of pixels corresponding to the pixel based on the correspondence information stored in the storing unit for each main scanning direction; and
writing including each of a plurality of writing units having different main scanning directions performing a writing process using the layout and the pixel values of the pixels replaced at the replacing following each main scanning direction.
